(19) United States
(12) Patent Application Publication
(10) Pub. No.: US 2026/0319841 A1
(43) Pub. Date: Oct. 15, 2026

(54) JOB SCHEDULING BASED ON CARBON EMISSION INFORMATION AND A POWER CONSUMPTION REDUCTION OBJECTIVE

(71) Applicant: HEWLETT PACKARD ENTERPRISE DEVELOPMENT LP, Spring, TX (US)

(72) Inventors: Diman Zad Tootaghaj, Milpitas, CA (US); Lianjie Cao, Milpitas, CA (US); Puneet Sharma, Palo Alto, CA (US)

(21) Appl. No.: 19/174,105

(22) Filed: Apr. 9, 2025

(51) Int. Cl. G06F 9/48

(52) U.S. Cl. CPC G06F 9/4893

(57) ABSTRACT

A system receives a request to schedule a first job in a system including a plurality of computing centers, each computing center comprising parallel processing units (PPUs). The system selects, based on carbon emission information for the plurality of computing centers, a first computing center of the plurality of computing centers in which to schedule the first job. The system allocates the first job to a PPU of multiple PPUs in the first computing center based on a power consumption reduction objective to reduce a power consumption associated with a usage of the multiple PPUs.

### BACKGROUND

Some computing systems include specialized processors or accelerators, which can be in the form of graphics processing units (GPUs), tensor processing units (TPUs), or neural processing units (NPUs), for example. A GPU, TPU, or NPU includes processing elements that can execute computations in parallel.

### BRIEF DESCRIPTION OF THE DRAWINGS

Some implementations of the present disclosure are described with respect to the following figures.

FIG. 1 is a block diagram of an arrangement including a carbon-aware hierarchical job scheduler to schedule jobs across parallel processing units (PPUs) of computing centers, according to some examples.

FIG. 2 is a flow diagram of a process of a tier 1 scheduler, according to some examples.

FIG. 3 is a flow diagram of a process of a tier 2 scheduler, according to some examples.

FIG. 4A and FIG. 4B are graphs of a power consumption profile, according to some examples.

FIG. 5 is a block diagram of a storage medium storing machine-readable instructions according to some examples.

FIG. 6 is a block diagram of a system according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Specialized processors or accelerators are processing units that are separate and distinct from a central processing unit (CPU) of a computing system. While the CPU is used to execute primary machine-readable instructions such as an operating system (OS), system firmware, and application programs, the specialized processors or accelerators include a relatively large quantity of processing elements that can perform computations (e.g., repetitive computations) independent of the CPU. The processing elements can perform the computations in parallel. Examples of specialized processors or accelerators include graphics processing units (GPUs), tensor processing units (TPUs), and neural processing units (NPUs). In the ensuing discussion, any of such specialized processors or accelerators can be referred to as parallel processing units (PPUs). Generally, a PPU includes multiple processing elements across which computation tasks of jobs can be allocated for execution. Within a computing system, a PPU is separate from the CPU of the computing system.

A “PPU” can thus refer to an individual GPU, a GPU fragment, TPU, NPU, or another accelerator. Alternatively, a “PPU” can refer to a set of multiple GPUs, GPU fragments, TPUs, NPUs, or other accelerators. The set of multiple GPUs, GPU fragments, TPUs, NPUs, or other accelerators may be part of a computing node or a cluster of computing nodes. Note that a PPU may be physical PPU or a virtual PPU.

PPUs may be deployed across computing centers, which may be located at different geographic locations and/or may be powered by different types of power sources. In some cases, the computing centers may include heterogeneous PPUs, which may include PPUs having different characteristics, such as PPUs from different vendors, different versions of PPUs that have different computing capacities, different types of PPUs, and so forth. Jobs associated with high-performance computing (HPC) applications, artificial intelligence (AI) workloads, or other workloads may be deployed across the PPUs in the computing centers. The scheduling of jobs across PPUs in computing centers may not consider the carbon footprint associated with the scheduling, and may not consider that the computing centers include heterogeneous PPUs. As a result, inefficient allocation of jobs to PPUs may lead to increased carbon emissions and power consumption.

In accordance with some implementations of the present disclosure, a carbon-aware scheduling system can schedule jobs across PPUs (which may be heterogeneous) in computing centers powered by different types of power sources, where the job scheduling considers carbon emission information in selecting a computing center for deploying a job, and allocates the job to a PPU in the selected computing center based on a power consumption reduction objective to reduce a power consumption associated with a usage of PPUs.

Techniques or mechanisms according to some examples of the present disclosure improve computer functionality or the relevant technology by reducing the carbon footprint and power consumption when scheduling jobs across PPUs in computing centers powered by different types of power sources. The scheduling of jobs can adapt as carbon footprints of computing centers change.

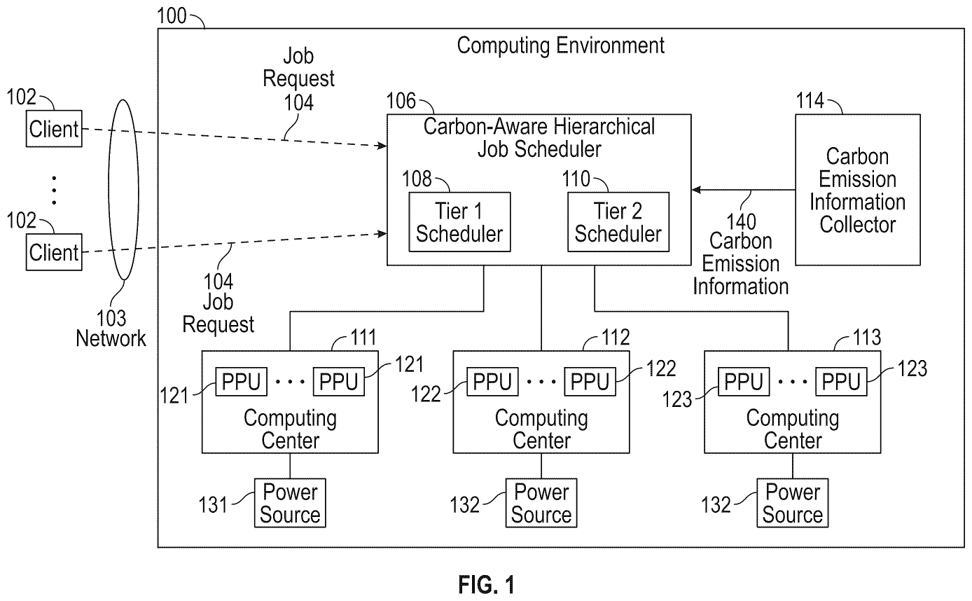

FIG. 1 is a block diagram of an arrangement including a computing environment 100 according to some examples of the present disclosure. The computing environment 100 includes multiple computing centers 111, 112, and 113. Although three computing centers are shown in FIG. 1, in other examples, the computing environment 100 may include less than three or more than three computing centers. Examples of computing centers include any or some combination of the following: data centers, cloud computing environments, clusters of computing nodes, individual computing nodes, or other collections of processing resources.

Each computing center includes a number of PPUs. For example, the computing center 111 includes PPUs 121, the computing center 112 includes PPUs 122, and the computing center 113 includes PPUs 123. In each computing center, a PPU is separate from a CPU that executes primary machine-readable instructions.

A PPU can refer to any of a GPU, a GPU fragment, a TPU, an NPU, or another type of accelerator. Alternatively, a PPU can refer to a set of GPUs, GPU fragments, TPUs, NPUs, or other accelerators. In the latter examples, each PPU (e.g., 121, 122, or 123) may refer to accelerators in a computing node or a cluster of computing nodes of a computing center. Note that a PPU may be physical PPU or a virtual PPU.

In some examples, a GPU can be divided into GPU fragments, which are referred to as Multi-Instance GPU (MIG) instances for NVIDIA GPUs or MxGPU instances for Advanced Micro Devices (AMD) GPUs. In other examples, GPU fragments can be provided by any other GPU virtualization approach from other vendors. Multiple MIG or MxGPU instances of different capacities may be provided in a GPU.

The computing center 111 is powered by a power source 131, the computing center 112 is powered by a power source 132, and the computing center 113 is powered by a power source 133. Different computing centers may be powered by different types of power sources, including hydrocarbon-based power generators, solar power sources, wind farms, other types of renewable energy power sources, or other types of power sources.

Different computing centers may be located at different geographic locations, such as different cities, different states, different countries, or other geographic locations. In further examples, two or more computing centers may be physically located within a common facility (e.g., a warehouse, an office building, etc.), but the two or more computing centers in the common facility may be powered by different types of power sources.

The computing centers and the PPUs in the computing centers make up computing resources that are accessible to clients 102 over a network 103. A “client” can refer to a human, a program (such as a containerized application program or any other type of program), or a machine (such as a computer or another type of electronic device). The computing resources are available to the clients 102 on demand (i.e., the resources are made available to clients 102 in response to job requests 104 from the clients 102.

The computing environment 100 includes a carbon-aware hierarchical job scheduler 106 to receive the job requests 104. The job scheduler 106 can be implemented using machine-readable instructions executed on one or more CPUs of the computing environment 100.

In some examples, the job scheduler includes a tier 1 scheduler 108 and a tier 2 scheduler 110, where the tier 1 scheduler 108 selects a computing center from among the computing centers 111 to 113 on which a job of a job request 104 is to be run, and the tier 2 scheduler 110 allocates the job to a selected PPU in the selected computing center.

The tier 1 scheduler 108 receives carbon emission information 140 from a carbon emission information collector 114, and the tier 1 scheduler selects the computing center from among the computing centers 111 to 113 for the job based on the carbon emission information. The tier 2 scheduler 110 allocates the job to a PPU based on a power consumption reduction objective to reduce the power consumption associated with usage of PPUs in the computing center selected by the tier 1 scheduler 108.

Although FIG. 1 shows the job scheduler 106 with two schedulers 108 and 110, in other examples, the schedulers 108 and 110 can be integrated into one scheduler, or the job scheduler 106 may include more than two schedulers.

In some examples, the carbon emission information collector 114 includes a WattTime collector that presents a WattTime application programming interface (API) through which the job scheduler 106 can obtain real-time carbon emission information.

The carbon emission information 140 from the carbon emission information collector 114 can include both projected and historical carbon emission information for various different power sources, including the power sources 131 to 133. In some examples, the carbon emission information 140 can include a Marginal Operating Emissions Rate (MOER) of each power source, where the MOER can be expressed in units of pounds of emissions per megawatt-hour (e.g., CO2 lbs/MWh). The MOER value represents the emissions rate of a power source (or carbon intensity of the power source), which quantifies the environmental impact of energy production. The MOER parameter is an example of a carbon intensity parameter. A lower MOER value indicates cleaner and more sustainable energy generation. In other examples, other parameters for quantifying the environmental impact of energy production for a power source can be used, such as metric ton of CO2 equivalent (CO2e), carbon intensity per kilowatt-hour (CIPK), etc.

In other examples, other types of carbon emission parameters can be provided by the carbon emission information collector 114. Instead of or in addition to carbon intensity, the carbon emission information 140 may include a carbon offset for a power source. A carbon offset refers to a technique in which a power generator (e.g., a utility company, an energy seller, etc.) compensates for carbon emissions by investing in other projects that reduce carbon emissions.

The carbon emission information collector 114 can be implemented using one or more computers and may include agents executed to collect information of respective power sources. The carbon emission information collector 114 may also obtain information of power sources from other information sources.

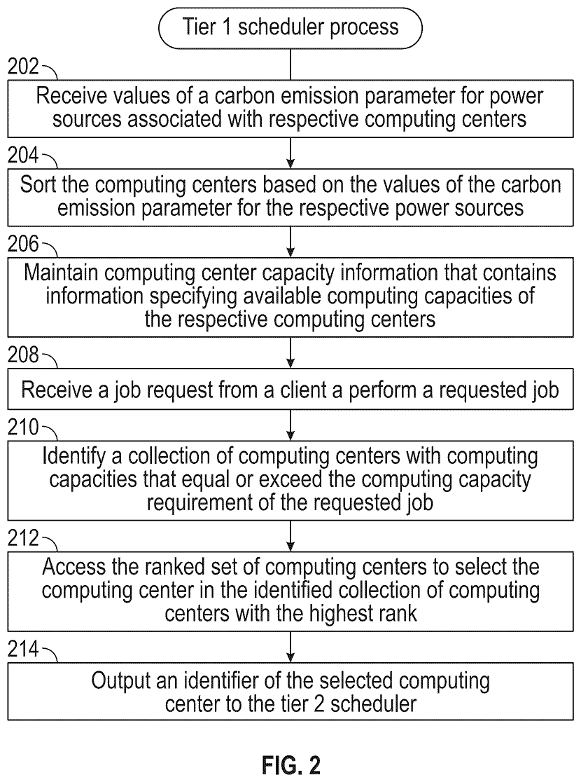

FIG. 2 is a flow diagram of a process performed by the tier 1 scheduler 108 according to some examples of the present disclosure. The tier 1 scheduler 108 is responsible for finding a computing center that has enough capacity to accommodate the load with the cleanest energy.

The tier 1 scheduler 108 receives (at 202) values of a carbon emission parameter (e.g., MOER values, carbon offsets, etc.) for power sources, including the power sources 131 to 133, associated with respective computing centers, including the computing centers 111 to 113. The tier 1 scheduler 108 sorts (at 204) the computing centers based on the values of the carbon emission parameter for the respective power sources. Information of the sorted computing centers (e.g., identifiers of the sorted computing centers) may be placed in a data structure, such as a queue, a table, or another data structure. For example, if the carbon emission parameter is a MOER parameter, the sorting produces a ranked set of computing centers, where a computing center with a lower MOER value is ranked higher than a computing center with a lower MOER value in the ranked set.

The tier 1 scheduler 108 also maintains (at 206) computing center capacity information that contains information specifying available computing capacities of the respective computing centers. An available computing capacity represents how many computations can be performed per unit time by available PPU(s) in a computing center. As jobs are scheduled on PPUs in a given computing center, the tier 1 scheduler 108 can adjust the computing center capacity information to reflect a change in the given computing center. Similarly, as jobs are completed by the given computing center, the computing center capacity information can be adjusted to reflect additional computing capacity available in the given computing center.

Note that values of the carbon emission parameter may change over time. As a result, the sorting (at 204) of computing centers can also change in response to changed values of the carbon emission parameter. In an example, the carbon emission information collector 114 can monitor the power sources for different computing centers to determine whether values of the carbon emission parameter are to be changed. The monitoring can be a periodic monitoring or monitoring in response to certain events.

The tier 1 scheduler 108 receives (at 208) a job request 104 from a client 102 to perform a requested job. The job request 104 can include a parameter specifying a computing capacity requirement of the requested job. This parameter can be referred to as Rᵢ for job i (job i is the requested job of the received job request 104). The tier 1 scheduler 108 identifies (at 210) a collection of computing centers with computing capacities that equal or exceed Rᵢ, i.e., the tier 1 scheduler 108 identifies computing center(s) with sufficient computing capacity to accommodate the computing capacity requirement, Rᵢ, for job i. The identified collection can include one or more computing centers with sufficient computing capacity.

The tier 1 scheduler 108 accesses the ranked set of computing centers to select (at 212) the computing center in the identified collection of computing centers with the highest rank (i.e., the computing center that has the lowest MOER value or other parameter value indicating the lowest environmental impact of energy production).

The tier 1 scheduler 108 outputs (at 214) an identifier of the selected computing center to the tier 2 scheduler 110. The tasks 208 to 214 can be re-iterated for other job requests received from client(s) 102.

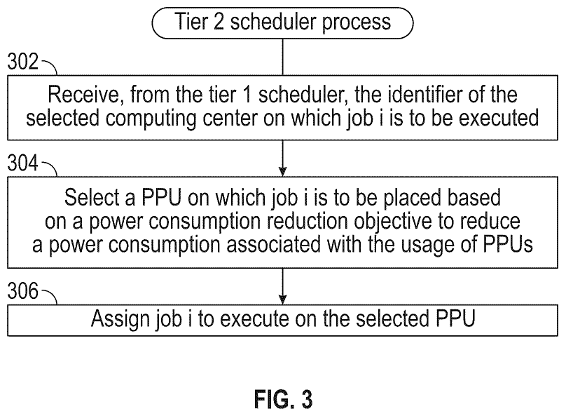

FIG. 3 is a process of the tier 2 scheduler 110 according to some examples of the present disclosure. The tier 2 scheduler 110 receives (at 302), from the tier 1 scheduler 108, the identifier of the selected computing center on which job i is to be executed. The tier 2 scheduler 110 selects (at 304) a PPU on which job i is to be placed based on a power consumption reduction objective to reduce a power consumption associated with the usage of PPUs. More specifically, in some examples, the tier 2 scheduler 110 performs job placement on PPUs to minimize the total power consumption using a bin-packing approach.

The tier 2 scheduler 110 then assigns (at 306) job i to execute on the selected PPU. Note that job i can be assigned to a single PPU (not to multiple PPUs), but multiple jobs may be assigned to one PPU. When job i is ready to run, job i can be loaded onto the selected PPU for execution.

In some examples, the scheduling problem for placing job i on a PPU of the selected computing center can be modeled as an integer linear programming (ILP) optimization problem, which is expressed in Eq. 1 below.

The formulation of Eq. 1 seeks to minimize power consumption subject to constraints 1a, 1b, 1c, and 1d.

$$Minimize {\sum }_{\{ j ∈ G \}} {f}_{j} ( {u}_{j} ) \qquad ( Eq . 1 )$$

$$subject to {\sum }_{i ∈ J} {R}_{i} {x}_{ij} \leq {C}_{j} {y}_{j} ∀ j ∈ G \qquad ( Constraint 1 a )$$

$${\sum }_{j ∈ G} {x}_{ij} = 1 ∀ i ∈ J \qquad ( Constraint 1 b )$$

$${u}_{j} = \frac{{\sum }_{i ∈ J} {R}_{i} {x}_{ij}}{{C}_{j}} ∀ j ∈ G \qquad ( Constraint 1 c )$$

$${x}_{ij} , {y}_{j} ∈ \{ 0 , 1 \} , ∀ i ∈ J , ∀ j ∈ G . \qquad ( Constraint 1 d )$$

In Eq. 1, ƒⱼ(uⱼ) represents the power consumption of PPU j in the selected computing center, and is a function of the PPU utilization of PPU j represented by uⱼ. The parameter uⱼ represents a proportion of PPU j that is being used. In some examples, uⱼ can be expressed as a percentage to represent a percentage of usage of PPU j by one or more jobs.

G represents the set of PPUs. The term

$$Minimize {\sum }_{\{ j ∈ G \}} {f}_{j} ( {u}_{j} )$$

in Eq. 1 seeks to minimize the sum ƒⱼ(uⱼ) for PPUs from the set of PPUs represented by G.

Note that in a computing center with heterogeneous PPUs, the power consumption functions ƒⱼ(uⱼ) of different types of PPUs may be different. For example, the power consumption function ƒ₁(u₁) of PPU 1 may be different from the power consumption function ƒ₂(u₂) of PPU 2. The formulation of Eq. 1 can thus account for heterogeneous PPUs when selecting a PPU to assign a job.

In Eq. 1, J represents the set of jobs running in the selected computing center. The variable xᵢⱼ is a binary variable specifying whether PPU j is used for job i. If xᵢⱼ=1, then that indicates job i is placed on PPU j for execution. On the other hand, if xᵢⱼ=0, then that indicates job i is not placed on PPU j for execution.

The variable yⱼ is a binary variable specifying whether PPU j is being used by any job. If yⱼ=1, then that indicates PPU j is being used. On the other hand, if yⱼ=0, then that indicates PPU j is not being used. The parameter Cⱼ represents the computing capacity of PPU j. As noted above, Rᵢ represents the computing capacity requirement of job i.

Constraint 1a ensures that the total computing capacity of PPU j (Cⱼyⱼ) is not exceeded by requirements of for jobs assigned to PPU j (Σ_{i∈J}Rᵢxᵢⱼ). Constraint 1b ensures that each job i is assigned to a single PPU (not to multiple PPUs).

Constraint 1c includes the PPU utilization definition, to ensure that the utilization of a PPU is the sum of the computing capacity requirements of all job(s) assigned to the PPU (Σ_{i∈J}Rᵢxᵢⱼ), divided by the PPU's capacity (Cⱼ).

Constraint 1d specifies that the variables xᵢⱼ and yⱼ have values selected from {0,1}, that i∈J, and that j∈G.

In some examples, to reduce total power consumption (and thus the total carbon footprint) of a computing center, the tier 2 scheduler 110 when finding a solution can co-locate multiple jobs on the same PPU.

Because solving the optimization problem represented by Eq. 1 is an NP-hard problem, an approximate solution can be computed to schedule job i on a selected PPU using one of various approximation techniques. Examples of approximation techniques that can be used include a piecewise linearization approximation technique or a convex relaxation technique.

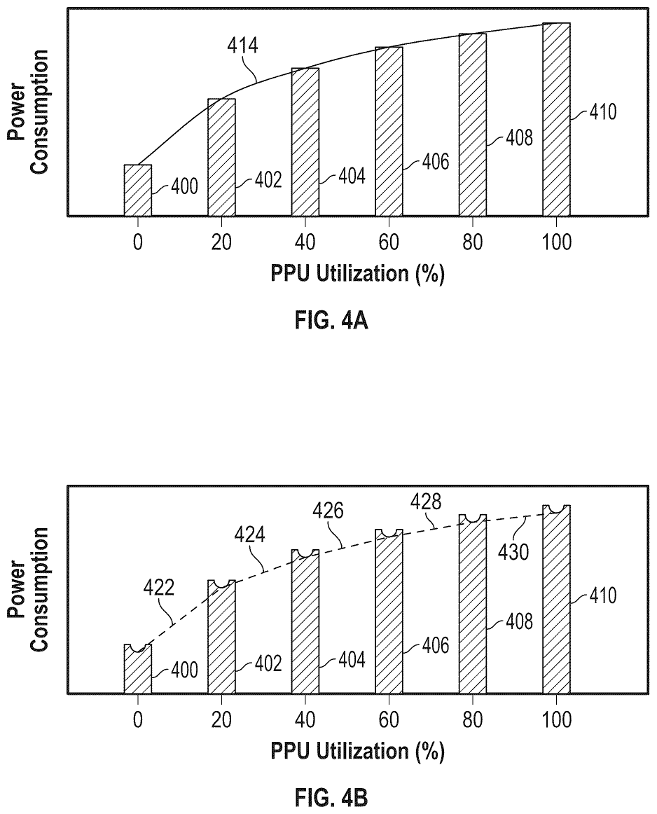

FIG. 4A shows an example of a concave function representing the power consumption profile of a PPU, where the power consumption profile represents power consumption of the PPU as a function of utilization of the PPU. Bars 400, 402, 404, 406, 408, and 410 represent the power consumption of the PPU at respective different utilizations of the PPU. The energy consumptions of PPUs may be monitored periodically or in response to other events.

Energy consumptions of PPUs may be obtained using any of various energy consumption measurement tools, such as the Kepler open-source tool or the WattTime open-source tool. An energy consumption measurement tool may present APIs that may be called by the job scheduler 106 to obtain the energy consumptions of PPUs.

The energy consumption measurement tool may output an energy metric that represents total power over time (energy consumption). To derive power consumption, energy consumption, E(t1), at a first time point (t1) and energy consumption, E(t2), at an earlier second time point (t0) may be obtained.

If t1 and t0 are close to one another, then power consumption, P(t1), at time t1 can be estimated as follows:

$$P ( t 1 ) = \frac{E ( t 1 ) - E ( t 0 )}{t 1 - t 0} . \qquad ( Eq . 2 )$$

As t1 approaches t0, i.e., the difference between t1 and t0 approaches 0, the estimated power consumption, P(t1), of a PPU at time t1 based on the energy consumption metrics become more accurate.

The estimated power consumption, P(t1), can be used to build the graph of FIG. 4A for respective utilizations of a PPU. As shown in FIG. 4A, a curve 414 fitted to the bars 400 to 410 has a general concave shape. The curve 414 is an example of the power consumption profile of the PPU, which represents power consumption (vertical axis) as a function of utilization (horizontal axis).

Note that Eq. 2 is based on the relationship of an instantaneous power consumption metric, P(t), to the energy consumption metric, E(t), as follows:

$$E ( t ) = {\int }_{t = 0}^{T} P ( t ) dt . \qquad ( Eq . 3 )$$

Because the PPU power function ƒⱼ(uⱼ) in Eq. 1 is generally concave, the power function can be approximated using a piecewise linearization approximation technique or a convex relaxation technique, for example.

### Piecewise Linear Approximation

With the piecewise linear approximation technique, the PPU power function ƒᵢ(uⱼ) is approximated with a set of linear segments 422, 424, 426, 428, and 430, as shown in FIG. 4B. More formally, the job scheduler 106 discretizes the utilization space uⱼ into K breakpoints

$${\{ {u}_{j}^{k} \}}_{k = 1}^{K} ,$$

where K≥2 and each linear segment is represented by a respective linear function. In the example of FIG. 4B, K=5, with five linear segments 422, 424, 426, 428, and 430 defined by the K breakpoints b₁, b₂, b₃, b₄, and b₅.

Each linear segment is defined between a respective start utilization of the PPU and a respective end utilization of the PPU. For example, the linear segment 422 is defined between a start utilization (0%) and an end utilization (b₁); the linear segment 424 is defined between a start utilization (b₁) and an end utilization (b₂); the linear segment 426 is defined between a start utilization (b₂) and an end utilization (b₃); and so forth.

The piecewise linear approximation technique reformulates the optimization problem of Eq. 1 as follows. The following additional decision variables are defined: λⱼₖ≥0,

$${f}_{j}^{k} , and {u}_{j}^{k} .$$

The variable λⱼₖ represents the weight assigned to breakpoint bₖ (k=1 to K) on PPU j. The weights assigned to the breakpoints may be based on the slopes of the linear segments defined by the breakpoints. For example, the weight λⱼ₁ assigned breakpoint b₁ can be the slope of linear segment 422, the weight λⱼ₂ assigned breakpoint b₂ can be the slope of linear segment 424, and so forth.

The variable

$${f}_{j}^{k}$$

represents the power consumption of PPU j for the linear segment corresponding to breakpoint bₖ, which is a function of the utilization

$${u}_{j}^{k}$$

of PPU j represented by the linear segment. For example,

$${f}_{j}^{1}$$

is the power consumption of PPU j for the linear segment 422 of FIG. 4B corresponding to breakpoint b₁, which is a function of the utilization

$${u}_{j}^{1}$$

of PPU j represented by the linear segment 422. Similarly,

$${f}_{j}^{4}$$

is the power consumption of PPU j for the linear segment 428 of FIG. 4B corresponding to breakpoint b₄, which is a function of the utilization

$${u}_{j}^{4}$$

of PPU j represented by the linear segment 428.

Eqs. 4-7 below set forth the constraints for the piecewise linear approximation technique. Eq. 4 defines the convex combination of breakpoints.

$${u}_{j} = {\sum }_{k = 1}^{K} {u}_{j}^{k} {λ}_{jk} , ∀ j ∈ G . \qquad ( Eq . 4 )$$

According to Eq. 4, the overall utilization, up, of PPU j is the sum across the K breakpoints of the products

$${u}_{j}^{k} {λ}_{jk} .$$

Eq. 5 defines the convex combination of power values.

$${f}_{j} ( {u}_{j} ) = {\sum }_{k = 1}^{K} {f}_{j}^{k} {λ}_{jk} , ∀ j ∈ G . \qquad ( Eq . 5 )$$

According to Eq. 5, the overall power consumption, ƒⱼ(uⱼ), of PPU j is the sum across the K breakpoints of the products

$${f}_{j}^{k} {λ}_{jk} .$$

Eq. 6 defines the sum of weights as being equal to 1.

$${\sum }_{k = 1}^{K} {λ}_{jk} = {y}_{j} , ∀ j ∈ G . \qquad ( Eq . 6 )$$

Eq. 7 defines the non-negativity constraints:

λⱼₖ≥0,∀j∈G,k∈{1, . . . ,K}. (Eq. 7)

With the reformulation for the piecewise linear approximation technique set forth above, the power function is linearized. As a result, the tier 2 scheduler 110 can apply a Mixed-Integer Linear Programming (MILP) solver to find a solution to assign a job to a PPU. Examples of MIPL solvers include the following: the Gurobi optimization toolkit, the CPLEX solver, or another solver.

### Approximation Using Greedy Rounding and Convex Relaxation

In further examples, the tier 2 scheduler 110 can use a convex relaxation technique to approximate the optimization problem of Eq. 1. For example, an approximation technique can use greedy rounding and convex relaxation. A convex relaxation of the ILP optimization problem of Eq. 1 allows the decision variables xᵢⱼ and yⱼ to be fractional (as opposed to being restricted to 0 and 1 values). Because the decision variables xᵢⱼ and yⱼ can be fractional, rounding can be applied to obtain a feasible integer solution while ensuring a bounded gap from the optimal solution achieved by solving Eq. 1. The approximate technique can round up any fractional values assigned the decision variables to obtain a feasible solution for allocating jobs to PPUs.

An example of a greedy rounding and convex relaxation technique uses a Best-Fit Decreasing (BFD) algorithm or a Modified First Fit (MFF) algorithm. The BFD algorithm or the MFF algorithm uses an online greedy strategy, in which jobs are placed iteratively on a PPU that leads to the smallest marginal increase in power. For a concave power function, the BFD algorithm guarantees a solution within at most a factor of 1.5 of the optimal solution in worst-case scenarios for the case where all PPUs are homogeneous and have the same capacity, or for the case where the PPUs are heterogeneous.

If the concavity of the power function is mild, the MFF algorithm may guarantee a solution within at most a factor of 1.22 of the optimal solution. A “mild” concavity of the power function refers to a concavity that approaches linearity.

In alternative examples, another approach is to solve a linear programming relaxation and then apply randomized rounding to obtain integer solutions that approximate the optimal solution.

The following describes the BFD and MFF algorithms in further detail.

### Best-Fit Decreasing (BFD) Algorithm

The BFD algorithm sorts jobs in decreasing order of requested PPU computing capacity requirements (Rᵢ). Assuming a set of jobs, J, that are to be scheduled by the tier 2 scheduler 110, the sorting of J produces a sorted set of jobs, J_{SORTED}, in which a job with a lower computing capacity requirement is placed higher in the sorted set than a job with a higher computing capacity. A job placed higher in the sorted set, J_{SORTED}, will be selected for assignment to a PPU before a job placed lower in the sorted set, J_{SORTED}.

The tier 2 scheduler 110 assigns a job from the sorted set, J_{SORTED}, to a selected PPU of the available PPUs (in set G) that results in the smallest marginal increase in power consumption.

After sorting the jobs to form the sorted set, J_{SORTED}, the tier 2 scheduler 110 initializes a set of PPUs, G, with utilization uⱼ=0 ∀j∈G. For each job in J_{SORTED}, the tier 2 scheduler 110 performs the following tasks (1) to (4).

(1) Find PPU j*∈G that leads to the smallest increase in power:

j*=argminⱼ(ƒⱼ(uⱼ+Rᵢ)−ƒⱼ(uⱼ)). (Eq. 8)

The computation, ƒⱼ(uⱼ+Rᵢ)−ƒⱼ(uⱼ), computes the marginal increase in power due to assigning job i having a computing capacity requirement, Rᵢ, to PPU j. The marginal increase in power, ƒⱼ(uⱼ+Rᵢ)−ƒⱼ(uⱼ), is computed for each PPU in the set G, to produce respective marginal increases in power for the corresponding PPUs. The computation argminⱼ(ƒⱼ(uⱼ+Rᵢ)−ƒⱼ(uⱼ)) compares the marginal increases in power due to assigning job i to the respective PPUs of the set G, and identifies the PPU j* from the set G with the minimum marginal increase in power if job i were assigned to PPU j*.

(2) If no existing PPU can accommodate job i, the tier 2 scheduler 110 allocates a new PPU j_{new} to add to the set G. Allocating a new PPU refers to adding a PPU that is not previously part of the set G to the set G. If task (2) evaluates to true, then j* is set to j_{new}.

(3) The tier 2 scheduler 110 assigns job i to PPU j* identified by task (1) or (2).

(4) The tier 2 scheduler 110 updates the utilization of PPU j* as follows: u_{j*}←u_{j*}+Rᵢ.

Tasks (1) to (4) are re-iterated for all jobs in the set J_{SORTED}. As a job from J_{SORTED} is assigned to a PPU, the job is removed from J_{SORTED}. The re-iterated tasks (1) to (4) produce PPU assignments in which jobs of J_{SORTED} are assigned to respective PPU(s).

(5) The tier 2 scheduler 110 returns the PPU assignments and power consumptions of the PPU(s) resulting from the assigned jobs.

The time complexity of the BFD algorithm can be as follows. The sorting of jobs to produce J_{SORTED} takes time O(n·log n), where n is the number of jobs in the set J. Finding the best PPU for each job takes time O(m), where m is the number of PPUs in the set G. Thus, the overall time complexity of the BFD algorithm can be O(n log n+n·m).

### Modified First Fit (MFF) Algorithm

The MFF algorithm places jobs in the first PPU that can fit the jobs, but modifies the placement strategy to reduce power consumption by preferring lower utilization PPUs ahead of higher utilization PPUs.

The tier 2 scheduler 110 sorts jobs in decreasing order of requested PPU computing capacity requirements (Rᵢ). Assuming a set of jobs, J, that are to be scheduled by the tier 2 scheduler 110, the sorting of J produces a sorted set of jobs, J_{SORTED}.

The tier 2 scheduler 110 assigns a job from the sorted set, J_{SORTED}, to a selected PPU of the available PPUs (in set G) according to tasks (a) to (e) below.

After sorting the jobs to form the sorted set, J_{SORTED}, the tier 2 scheduler 110 initializes a set of PPUs, G, with utilization uⱼ=0 ∀j∈G. For each job in J_{SORTED}, the tier 2 scheduler 110 performs the following tasks (a) to (e).

(a) The tier 2 scheduler 110 attempts to assign job i to the first PPU j∈G such that:

uⱼ+Rᵢ≤Cⱼ(PPU capacity constraint). (Eq. 9)

(b) If multiple PPUs can accommodate job i, the tier 2 scheduler 110 chooses the PPU j* that satisfies:

j*=argminⱼ(Pⱼ(uⱼ+Rᵢ)). (Eq. 10)

The computation Pⱼ(uⱼ+Rᵢ) of Eq. 10 derives a resultant (increased) power consumption of PPU j due to adding the computing capacity requirement Rᵢ of job i to PPU j, which has a utilization uⱼ prior to the assignment of job i to PPU j. The resultant power consumption is computed for each PPU in the set G, to produce respective resultant power consumptions for the corresponding PPUs. The computation argminⱼ(Pⱼ(uⱼ+Rᵢ)) compares the resultant power consumptions due to assigning job i to the respective PPUs of the set G, and identifies the PPU j* from the set G with the minimum resultant power consumption. Effectively, this tends to prefer lower utilization PPUs ahead of higher utilization PPUs.

(c) If no existing PPU can accommodate job i, the tier 2 scheduler 110 allocates a new PPU j_{new} to add to the set G.

(d) The tier 2 scheduler 110 assigns job i to PPU j* identified by task (b) or (c).

(e) The tier 2 scheduler 110 updates the utilization of PPU j* as follows: u_{j*}←u_{j*}+Rᵢ.

Tasks (a) to (e) are re-iterated for all jobs in the set J_{SORTED}. As a job from J_{SORTED} is assigned to a PPU, the job is removed from J_{SORTED}. The re-iterated tasks (a) to (e) produce PPU assignments in which jobs of J_{SORTED} are assigned to respective PPU(s).

(f) The tier 2 scheduler 110 returns the PPU assignments and power consumptions of the PPU(s) resulting from the assigned jobs.

The time complexity of the MFF algorithm is similar to the time complexity of the BFD algorithm discussed further above.

### Power Capping

In some examples, the job scheduler 106 can apply power capping of a PPU to reduce power consumption of the PPU. Power capping refers to setting a maximum allowable power consumption of the PPU. In some examples, power capping can be based on jobs assigned to the PPU.

The maximum power consumption of a PPU, Max_{power} (the power cap), can be dynamically tuned (adjusted) by the job scheduler 106. If a given job allocated to the PPU uses x percentage of the PPU, then it can be assumed that the peak power consumption of the given job on the PPU is x·Max_{power}. If multiple jobs are assigned to the PPU, and the total peak power consumptions of the multiple jobs is less than Max_{power}, the job scheduler 106 can tune Max_{power} to a lower value that is equal or greater than the total peak power consumptions of the multiple jobs. In this way, the job scheduler 106 can restrict the maximum power consumption of each PPU and thus reduce carbon emissions of the PPU.

### FURTHER EXAMPLES

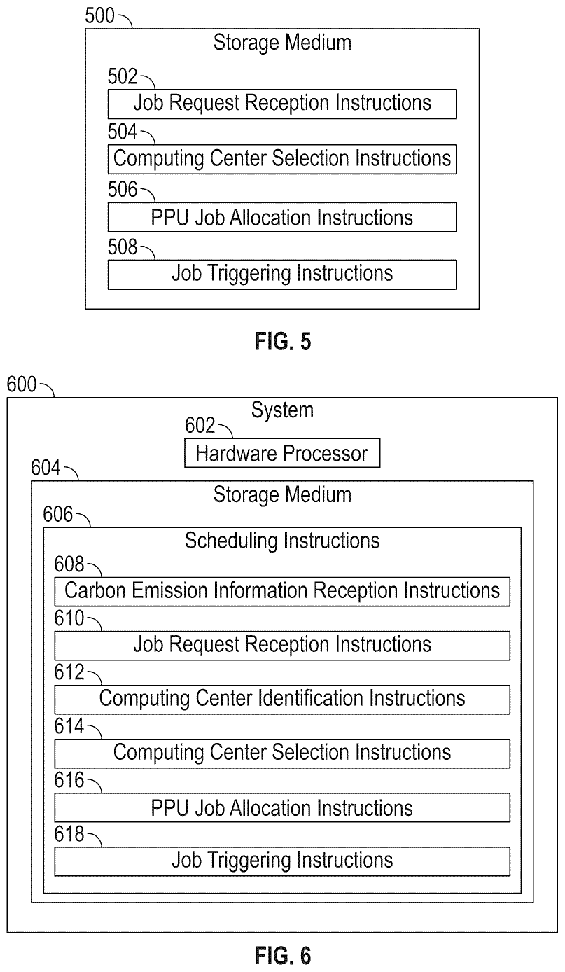

FIG. 5 is a block diagram of a non-transitory machine-readable or computer-readable storage medium 500 storing machine-readable instructions that upon execution cause a system to perform various tasks. The system can include one or more computers. The machine-readable instructions may include scheduling instructions executed by the job scheduler 106 of FIG. 1.

The machine-readable instructions include job request reception instructions 502 to receive a request to schedule a first job in a computing environment having a plurality of computing centers (e.g., 111 to 113 in FIG. 1). Each computing center includes PPUs (e.g., 121 to 123 in FIG. 1).

The machine-readable instructions include computing center selection instructions 504 to select, based on carbon emission information for the plurality of computing centers, a first computing center of the plurality of computing centers in which to schedule the first job. The carbon emission information may be received from the carbon emission information collector 114 of FIG. 1, for example.

The machine-readable instructions include PPU job allocation instructions 506 to allocate the first job to a PPU of multiple PPUs in the first computing center based on a power consumption reduction objective to reduce a power consumption associated with a usage of the multiple PPUs. For example, the power consumption reduction objective can be a power consumption minimization objective to minimize the power consumption associated with the usage of the multiple PPUs. Eq. 1 represents an optimization problem that includes the power consumption minimization objective.

The machine-readable instructions include job triggering instructions 508 to trigger processing of the first job on the PPU. For example, the triggering can be accomplished by sending information of the first job along with information of the assigned PPU to the first computing center.

In some examples, the power consumption reduction objective is subject to a constraint specifying that a cumulative requested computing capacity of one or more jobs allocated to the PPU does not exceed a total computing capacity of the PPU. An example of this constraint is constraint 1a in Eq. 1.

In some examples, the power consumption reduction objective is subject to a constraint specifying that the first job is assigned to a single PPU. An example of this constraint is constraint 1b in Eq. 1.

In some examples, a power consumption of the PPU is a function of a utilization of the PPU by one or more jobs allocated to the PPU, and the utilization of the PPU is based on a sum of one or more requested computing capacities of the one or more jobs allocated to the PPU divided by a total computing capacity of the PPU. A requested computing capacity of a job can be represented by Rᵢ, for example.

In some examples, a power consumption profile of the PPU is represented by a concave function, the power consumption profile representing a power consumption of the PPU with respect to utilizations of the PPU. An example of the power consumption profile is represented by 414 in FIG. 4A.

In some examples, the allocating of the first job to the PPU based on the power consumption reduction objective includes performing a piecewise linear approximation of the power consumption reduction objective by dividing the concave function into a plurality of linear segments (e.g., 422 to 430 in FIG. 4B).

In some examples, each respective linear segment of the plurality of linear segments is defined between a respective start utilization of the PPU and a respective end utilization of the PPU.

In some examples, the allocating of the first job to the PPU can use an MILP solver.

In some examples, the allocating of the first job to the PPU based on the power consumption reduction objective includes applying a convex relaxation of an integer linear programming (ILP) optimization problem including the power consumption reduction objective. The convex relaxation allows fractional values of decision variables representing allocations of jobs to PPUs and usage of PPUs.

In some examples, the system can round up any fractional values assigned the decision variables to obtain a feasible solution for allocating jobs to PPUs.

In some examples, the allocating of the first job to the PPU based on the power consumption reduction objective includes finding a first PPU from among the multiple PPUs that leads to a smallest increase in power consumption when the first job is placed on the first PPU. The first job is allocated to the first PPU. An example of such an allocation uses the BFD algorithm.

In some examples, the allocating of the first job to the PPU based on the power consumption reduction objective further includes sorting jobs in decreasing order of requested computing capacities of the jobs. The first job is selected from the sorted jobs.

In some examples, the allocating of the first job to the PPU based on the power consumption reduction objective includes identifying plural PPUs with capacities to accommodate the first job, determining resultant power consumptions of the plural PPUs due to adding the first job to the plural PPUs, and selecting a PPU from the plural PPUs with a minimum resultant power consumption from among the determined resultant power consumptions. The first job is allocated to the selected PPU. An example of such an allocation uses the MFF algorithm.

In some examples, the selecting of the first computing center of the plurality of computing centers in which to schedule the first job is based on comparing values of a carbon emission parameter for respective power sources of the plurality of computing centers. The carbon emission parameter can include a MOER parameter or a carbon offset, for example.

FIG. 6 is a block diagram of a system 600 according to some examples of the present disclosure. The system 600 can be implemented with one or more computers.

The system 600 includes a hardware processor 602 (or multiple hardware processors). A hardware processor can include a microprocessor, a core of a multi-core microprocessor, a microcontroller, a programmable integrated circuit, a programmable gate array, or another hardware processing circuit.

The system 600 includes a storage medium 604 storing scheduling instructions 606 executable on the hardware processor 602 to perform various tasks. The scheduling instructions 606 can be part of the job scheduler 106 of FIG. 1, for example. Machine-readable instructions executable on a hardware processor can refer to the instructions being executable on a single hardware processor or the instructions being executable on multiple hardware processors.

The scheduling instructions 606 include carbon emission information reception instructions 608 to receive carbon emission information of power sources for a plurality of computing centers. Each computing center includes PPUs.

The scheduling instructions 606 include job request reception instructions 610 to receive a request to schedule a first job having a requested computing capacity. A requested computing capacity of a job can be represented by Rᵢ, for example.

The scheduling instructions 606 include computing center identification instructions 612 to identify multiple computing centers of the plurality of computing centers with available computing capacities that satisfy the requested computing capacity.

The scheduling instructions 606 include computing center selection instructions 614 to select, based on carbon emission information for the multiple computing centers, a first computing center of the plurality of computing centers in which to schedule the first job. The selection can be based on comparing values of a carbon emission parameter for multiple power sources of the multiple computing centers.

The scheduling instructions 606 include PPU job allocation instructions 616 to allocate the first job to a PPU of multiple PPUs in the first computing center based on a power consumption reduction objective to reduce a power consumption associated with a usage of the multiple PPUs.

The scheduling instructions 606 include job triggering instructions 618 to trigger processing of the first job on the PPU. The triggering can include sending information of the first job and the assigned PPU to the first computing center so that the first job starts running on the assigned PPU.

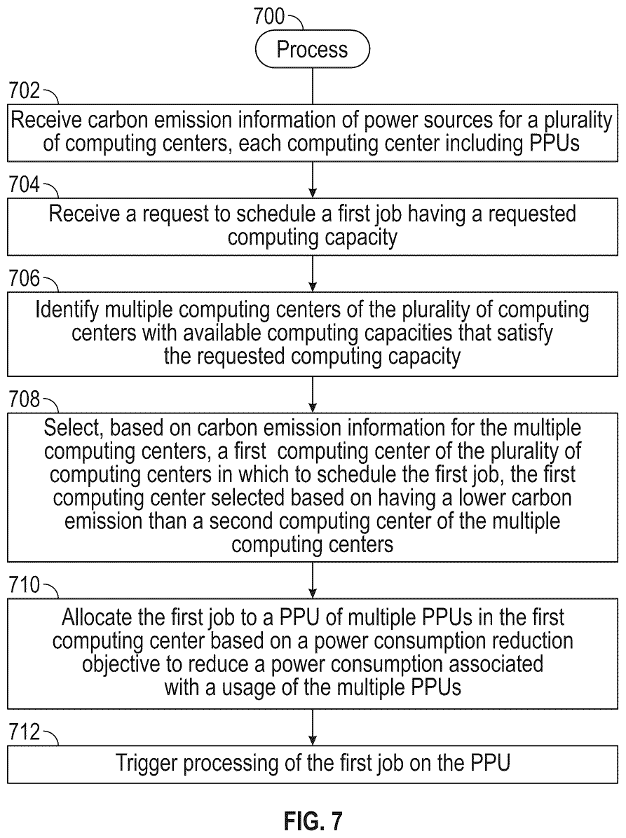

FIG. 7 is a flow diagram of a process 700 according to some examples of the present disclosure. The process 700 may be performed by the job scheduler 106 of FIG. 1, for example.

The process 700 includes receiving (at 702) carbon emission information of power sources for a plurality of computing centers, each computing center including PPUs. The carbon emission information can include values of a carbon emission parameter.

The process 700 includes receiving (at 704) a request to schedule a first job having a requested computing capacity. The request may be received from a client.

The process 700 includes identifying (at 706) multiple computing centers of the plurality of computing centers with available computing capacities that satisfy the requested computing capacity. A computing center has an available computing capacity that satisfies the requested computing capacity if the available computing capacity is equal to or greater than the requested computing capacity.

The process 700 includes selecting (at 708), based on carbon emission information for the multiple computing centers, a first computing center of the plurality of computing centers in which to schedule the first job, the first computing center selected based on having a lower carbon emission than a second computing center of the multiple computing centers.

The process 700 includes allocating (at 710) the first job to a PPU of multiple PPUs in the first computing center based on a power consumption reduction objective to reduce a power consumption associated with a usage of the multiple PPUs. In some examples, the allocating of the first job to the PPU based on the power consumption reduction objective uses an approximation technique selected from among a piecewise linearization approximation technique or a convex relaxation technique, for example.

The process 700 includes triggering (at 712) processing of the first job on the PPU.

As used here, a “CPU” can include one or more hardware processors. An “electronic device” can refer to any or some combination of a desktop computer, a notebook computer, a tablet computer, a smartphone, or any other type of electronic device.

FIGS. 2, 3, and 7 are flow diagrams of processes including tasks performed in depicted orders. In other examples, the tasks of any of the processes may be performed in a different order, some of the tasks may be omitted, and other tasks may be added.

A storage medium (e.g., 500 in FIG. 5 or 604 in FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive a request to schedule a first job in a computing environment comprising a plurality of computing centers, each computing center comprising parallel processing units (PPUs);
select, based on carbon emission information for the plurality of computing centers, a first computing center of the plurality of computing centers in which to schedule the first job;
allocate the first job to a PPU of multiple PPUs in the first computing center based on a power consumption reduction objective to reduce a power consumption associated with a usage of the multiple PPUs; and
trigger processing of the first job on the PPU.

2. The non-transitory machine-readable storage medium of claim 1, wherein the power consumption reduction objective is subject to a constraint specifying that a cumulative requested computing capacity of one or more jobs allocated to the PPU does not exceed a total computing capacity of the PPU.

3. The non-transitory machine-readable storage medium of claim 1, wherein the power consumption reduction objective is subject to a constraint specifying that the first job is assigned to a single PPU.

4. The non-transitory machine-readable storage medium of claim 1, wherein a power consumption of the PPU is a function of a utilization of the PPU by one or more jobs allocated to the PPU, and wherein the utilization of the PPU is based on a sum of one or more requested computing capacities of the one or more jobs allocated to the PPU divided by a total computing capacity of the PPU.

5. The non-transitory machine-readable storage medium of claim 1, wherein a power consumption profile of the PPU is represented by a concave function, the power consumption profile representing a power consumption of the PPU with respect to utilizations of the PPU.

6. The non-transitory machine-readable storage medium of claim 5, wherein the allocating of the first job to the PPU based on the power consumption reduction objective comprises performing a piecewise linear approximation of the power consumption reduction objective by dividing the concave function into a plurality of linear segments.

7. The non-transitory machine-readable storage medium of claim 6, wherein each respective linear segment of the plurality of linear segments is defined between a respective start utilization of the PPU and a respective end utilization of the PPU.

8. The non-transitory machine-readable storage medium of claim 6, wherein the allocating of the first job to the PPU uses a Mixed-Integer Linear Programming (MILP) solver.

9. The non-transitory machine-readable storage medium of claim 1, wherein the allocating of the first job to the PPU based on the power consumption reduction objective comprises applying a convex relaxation of an integer linear programming (ILP) optimization problem comprising the power consumption reduction objective, the convex relaxation allowing fractional values of decision variables representing allocations of jobs to PPUs and usage of PPUs.

10. The non-transitory machine-readable storage medium of claim 9, wherein the instructions upon execution cause the system to:
round up any fractional values assigned the decision variables to obtain a feasible solution for allocating jobs to PPUs.

11. The non-transitory machine-readable storage medium of claim 1, wherein the allocating of the first job to the PPU based on the power consumption reduction objective comprises:
finding a first PPU from among the multiple PPUs that leads to a smallest increase in power consumption when the first job is placed on the first PPU,
wherein the first job is allocated to the first PPU.

12. The non-transitory machine-readable storage medium of claim 11, wherein the allocating of the first job to the PPU based on the power consumption reduction objective further comprises:
sorting jobs in decreasing order of requested computing capacities of the jobs;
selecting the first job from the sorted jobs.

13. The non-transitory machine-readable storage medium of claim 1, wherein the allocating of the first job to the PPU based on the power consumption reduction objective comprises:
identifying plural PPUs with capacities to accommodate the first job;
determining resultant power consumptions of the plural PPUs due to adding the first job to the plural PPUs;
selecting a PPU from the plural PPUs with a minimum resultant power consumption from among the determined resultant power consumptions,
wherein the first job is allocated to the selected PPU.

14. The non-transitory machine-readable storage medium of claim 1, wherein the selecting of the first computing center of the plurality of computing centers in which to schedule the first job is based on comparing values of a carbon emission parameter for respective power sources of the plurality of computing centers.

15. The non-transitory machine-readable storage medium of claim 14, wherein the carbon emission parameter comprises a Marginal Operating Emissions Rate (MOER) parameter or a carbon offset.

16. A system comprising:
a hardware processor; and
a non-transitory storage medium storing scheduling instructions executable on the hardware processor to:
receive carbon emission information of power sources for a plurality of computing centers, each computing center comprising parallel processing units (PPUs);
receive a request to schedule a first job having a requested computing capacity;
identify multiple computing centers of the plurality of computing centers with available computing capacities that satisfy the requested computing capacity;
select, based on carbon emission information for the multiple computing centers, a first computing center of the plurality of computing centers in which to schedule the first job;
allocate the first job to a PPU of multiple PPUs in the first computing center based on a power consumption reduction objective to reduce a power consumption associated with a usage of the multiple PPUs; and
trigger processing of the first job on the PPU.

17. The system of claim 16, wherein the scheduling instructions are executable on the hardware processor to:
allocate the first job to the PPU based on applying a piecewise linear approximation of the power consumption reduction objective.

18. The system of claim 16, wherein the scheduling instructions are executable on the hardware processor to:
allocate the first job to the PPU based on applying a convex relaxation technique that seeks to minimize an increase in power consumption due to allocating the first job to the PPU or minimize a resultant power consumption due to allocating the first job.

19. A method comprising:
receiving, by a system comprising a hardware processor, carbon emission information of power sources for a plurality of computing centers, each computing center comprising parallel processing units (PPUs);
receiving, by the system, a request to schedule a first job having a requested computing capacity;
identifying, by the system, multiple computing centers of the plurality of computing centers with available computing capacities that satisfy the requested computing capacity;
selecting, based on carbon emission information for the multiple computing centers, a first computing center of the plurality of computing centers in which to schedule the first job, the first computing center selected based on having a lower carbon emission than a second computing center of the multiple computing centers;
allocating, by the system, the first job to a PPU of multiple PPUs in the first computing center based on a power consumption reduction objective to reduce a power consumption associated with a usage of the multiple PPUs; and
triggering, by the system, processing of the first job on the PPU.

20. The method of claim 19, wherein the allocating of the first job to the PPU based on the power consumption reduction objective uses an approximation technique selected from among a piecewise linearization approximation technique or a convex relaxation technique.
